(19) United States
(12) Patent Application Publication
(10) Pub. No.: US 2015/0088493 A1
(43) Pub. Date: Mar. 26, 2015

(54) PROVIDING DESCRIPTIVE INFORMATION ASSOCIATED WITH OBJECTS

(71) Applicant: Amazon Technologies, Inc., Reno, NV (US)

(72) Inventor: Mayank Thakore, Seattle, WA (US)

(73) Assignee: Amazon Technologies, Inc., Reno, NV (US)

(21) Appl. No.: 14/032,817

(22) Filed: Sep. 20, 2013

(51) Int. Cl. G06F 17/27

(52) U.S. Cl. CPC G06F 17/2735
USPC 704/10

(57) ABSTRACT

Techniques for providing descriptive information associated with objects may be provided. For example, requests to define an object may be received and monitored. When the number of requests indicates that a definition of the object should be updated, the definition of the object may be obtained and a reference for defining the object may be determined. Information for updating the reference with the definition may be transmitted to one or more associated computing devices.

### BACKGROUND

In this day and age, information can be communicated in various formats that include a wide range of tangible media of expression. Papers, files, drawings, books, and the like are only a few examples. Recent trends also indicate a growing adoption of electronic formats (e.g., e-books) coupled with an increasing user reliance on computing devices to access information.

As computing devices become more widespread and advanced, more and more users turn to the computing devices for enabling a multitude of different functions, features, and/or software applications. For example, computing devices may be configured to be used as word processors, document readers, or multimedia file players. These configurations generally allow a computing device to present information in one, two, three, or four-dimensional formats and a user to select a format to his or her liking. The user experience can be further enhanced with additional information such as descriptions associated with the presented information.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 illustrates an example computing device for presenting descriptive information to a user, according to embodiments;

FIG. 2A illustrates an example flow diagram for presenting the descriptive information to the user, according to embodiments;

FIG. 2B illustrates an example flow diagram for obtaining a reference that may include descriptive information, according to embodiments;

FIG. 2C illustrates another example flow diagram for obtaining a reference that may include descriptive information, according to embodiments

FIG. 3 illustrates an example architecture for obtaining descriptive information, including at least one user device and/or one or more service provider computers connected via one or more networks, according to embodiments;

FIG. 4 illustrates an example structure for managing descriptive information at a service provider computer, according to embodiments;

FIG. 5 illustrates an example flow diagram for determining when certain information may be added to a reference, according to embodiments;

FIG. 6 illustrates an example flow diagram for determining when the certain information may be added to another reference, according to embodiments;

FIG. 7 illustrates an example flow diagram for determining a reference that certain information may be added to, according to embodiments;

FIG. 8 illustrates an example flow diagram for pushing certain information from the service provider computer, according to embodiments;

FIG. 9 illustrates an example flow diagram for pulling certain information from the service provider computer, according to embodiments;

FIG. 10 illustrates an example flow diagram for removing certain information from a reference, according to embodiments; and

FIG. 11 illustrates an environment in which various embodiments described herein can be implemented, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, enhancing the user experience when accessing information by way of a computing device. In the interest of clarity of explanation, the embodiments are described herein with reference to accessing electronic documents, such as books, papers, magazines, newspapers, files, and other documents accessible in an electronic format. However, the described techniques can also be applied to other formats and media of expression.

As described below, techniques herein may enhance a user's experience by providing one or more dictionaries associated with one or more electronic documents. As used herein, a dictionary may include any type of reference that may define an object used within a document. As examples, the dictionary may include a list of objects and their definitions, an interactive encyclopedia, a descriptive database, or an appendix to the document. Further, as used herein, an object may include any single or multiple elements that may convey information when communicated to a user. A word, a character, a formula, an equation, an image, a video, or a character from a story may be examples of an object. Also, as used herein, a definition may include any description that may convey descriptive information about the object such as explanatory words, synonyms, antonyms, translations, images, videos, solutions to equations, or other information.

Generally, computing resources of a service provider may store dictionaries, whereas a computing device of a user may locally store or may remotely access a certain number, portions of, and/or versions of the dictionaries. Based on various considerations, including memory management, resource allocation, licensing fees, costs, or other considerations, the dictionaries available to the computing device, whether locally or remotely, may not be as extensive as the dictionaries of the service provider (which may be referred to as “network-based dictionaries” or “service provider dictionaries”). For example, a dictionary available on the computing device (which may be referred to as a “global dictionary”) may include definitions of the most commonly used words of the English language, whereas a service provider dictionary may have definitions of all or almost all of the English words.

The global dictionaries can be configured to provide definitions to applications hosted on the computing device (in this case, the dictionaries may be referred to as “device dictionaries”) or to a number of these applications (in this case, the dictionaries may be referred to as “application dictionaries”). Other types of dictionaries may be also available the computing device such as one that may be specific to a document. For example, when an e-book is downloaded to the computing device from a computing resource of the service provider, a dictionary customized to the objects of that e-book may be also downloaded and stored on the computing device. This type of dictionaries may be referred to as “local dictionaries” or “custom dictionaries.”

When the user desires to access a definition of an object, the computing device may first attempt to retrieve the definition from a global or local dictionary. But if unavailable thereat, the computing device may attempt to obtain the definition from a service provider dictionary or from another source (e.g., a public website hosting a dictionary), subject to bandwidth and cost, among other constraints. For example, if a connection does not exist between the computing device and the computing resources of the service provider during a certain period of time, the computing device will likely not be able to obtain the definition during that period. Even if a connection existed but the computing device was, for example, in a roaming state, it may be cost prohibitive to obtain the definition, be it a short string of words or a long multimedia file.

To enhance the user experience and minimize impacts of the constraints, the content of the global and local dictionaries may be improved. For example, relevant definitions may be included in these dictionaries when they are first made available to the computing device. To do so, when a global or local dictionary is initially generated, the service provider may include definitions of objects that the user may likely request. For example, the service provider may include definitions of the most commonly searched words of the English language in a global dictionary or the most used words in a document in a custom dictionary. Also, in the case of a custom dictionary specific to a document, the service provider may request the author of the document to list the definitions that need to be included.

To further enhance the user experience, and subsequent to generating the global or local dictionary, the dictionary may be maintained and updated. For example, when the service provider determines that an existing definition of an object needs to be updated or a new definition needs to be added, the service provider may update the dictionary accordingly. Such an object may be referred to herein as a “hot object” or an “object that is hot.” This can be the case when, for instance, a user (e.g., an author of a document associated with the dictionary) provides input to the service provider indicating that the definition needs to be added, edited, updated, or deleted. This can also be the case when, for instance, the service provider determines that the existing definition is outdated.

In another example, the service provider may monitor searched objects that do not have current definitions in the dictionary. Metrics associated with this monitoring may be used to determine whether the dictionary should be updated with the corresponding definitions. For instance, the service provider may set-up a counter that tracks the number of times a definition of an object is requested (e.g., when the computing device does not find the definition in the global or local dictionary and obtains it, instead, from the service provider dictionary). When the counter exceeds a certain threshold, the service provider may decide to update the global or local dictionary with the definition and the object may be referred to herein also as a “hot object” or “an object that is hot.” In that case, the service provider may retrieve the definition from its service provider dictionary and/or may request the definition from other users, such as from avid or experienced readers, writers, or editors, or from authors of associated documents. Thereafter, the service provider can push the obtained definition to the computing device with instructions to update the global or local dictionary. Similarly, the computing device may pull the obtained definition from a computing resource of the service provider. As such, the global and local dictionaries may not only contain definitions of the most commonly used objects, but may also include, for example, definitions of the most commonly searched objects.

In addition to monitoring and defining hot objects, associated contexts may also be used to enhance the user experience. As used herein, a “context” may refer to any information that may clarify a use of an object. For example, a context of a word may include a sentence in which the word is used, an identifier of an author of a document that contains the word, or a citation to the document (e.g., document identification such as an international standard book number—ISBN—or a title, along with a chapter, a page, a paragraph, and a line number). In another example, a context of a scene within a multimedia file may include a description of the mise en scène.

Various techniques may be used to generate a context. For example, a computing resource of the service provider may not only receive requests to define a hot object from a computing device, but may also receive the associated context. Similarly when asking users for a definition, the service provider may also request the context from those users. In this case, the context may additionally include one or more comments from the users. For example, a context of a word used in a sentence may be a reader's interpretation of the use of the word within that sentence or an author's annotation of the choice of words in the sentence.

As such, when users request a definition of an object not listed in global or local dictionaries of their computing devices, their requests, and optionally the corresponding contexts, can be transmitted to one or more computing resources of the service provider. The service provider may track the number of requests and, when the number exceeds a threshold, may flag the object as hot and decide to include its definition and a relevant context in some or all of the global dictionaries (e.g., when the requests are associated with multiple documents that contain the object) or local dictionaries (e.g., when the requests are specific to a common document that contains the object). The definition, and optionally the context, may be included in subsequent editions of the global and local dictionaries or may be pushed to the computing devices. Additionally or alternatively, the computing devices may also immediately pull the definition. These and other functionalities are further described in the next figures.

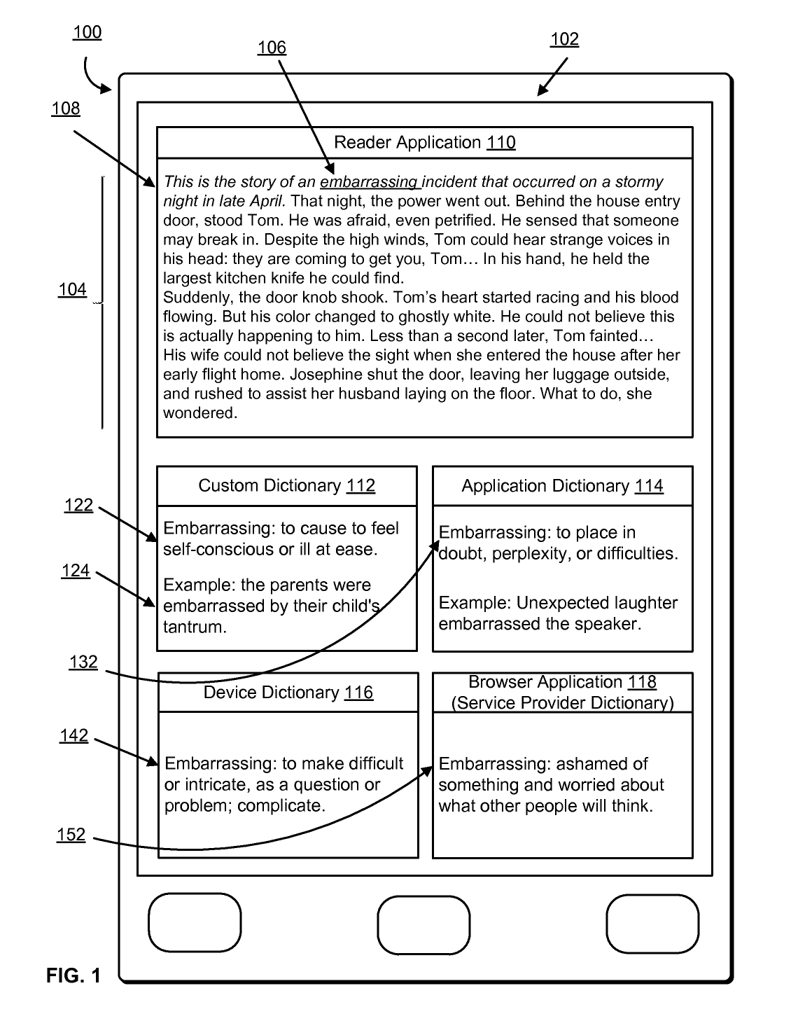

FIG. 1 depicts an illustrative computing device 100 such as, but not limited to, an electronic book (e-book) reader, a computing tablet, a smartphone, a mobile device, a personal electronic device, a personal computer, or any other type of computing devices that may be configured to implement the techniques described herein. In particular, computing device 100 may be configured to present information to a user and may allow him or her to interactively request and view definitions of associated objects. For example, the user may view a document 104 (e.g., an e-book) and may select an object 106 within the document (e.g., a word; shown in FIG. 1 as the word “embarrassing” with an italicized and underlined font) along with its context 108 (e.g., a sentence that contains the selected word; shown with an italicized font). In turn, computing device 100 may return and present one or more definitions of object 106 (e.g., a descriptive string of words; shown as a custom definition 122, an application definition 132, a device definition 142, and a service provider definition 152) and one or more example of use of the object (e.g., a descriptive string of words; shown as custom example 124).

As is further exemplified FIG. 1, to facilitate the interaction with the user, computing device 100 may be configured to provide a user interface 102 that may use touch screen and other technologies. User interface 102 may include one or more windows that may display outputs of and may allow inputs to one or more processes. A reader application 110 is an example of such processes and may be configured to present document 104 and to allow the selection of object 106 and context 108. Other processes can also be used such as ones for retrieving and presenting the definitions from a custom dictionary 112, an application dictionary 114, or a device dictionary 114. These processes may also include a browser application 118 for retrieving a definition from a service provider dictionary.

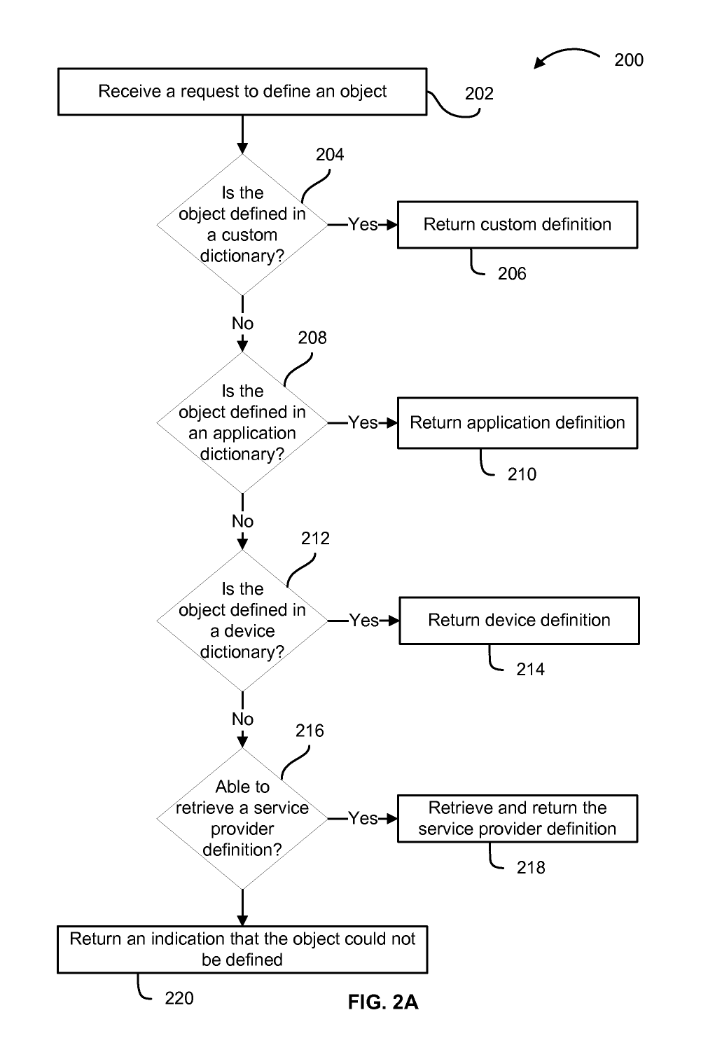

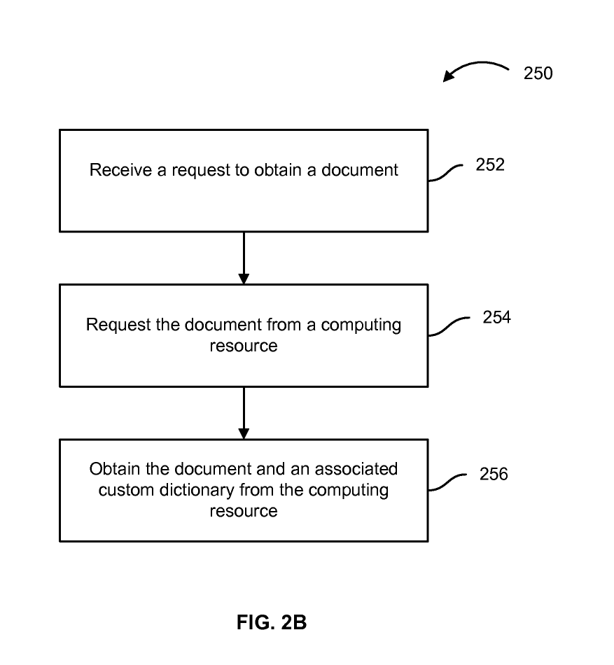

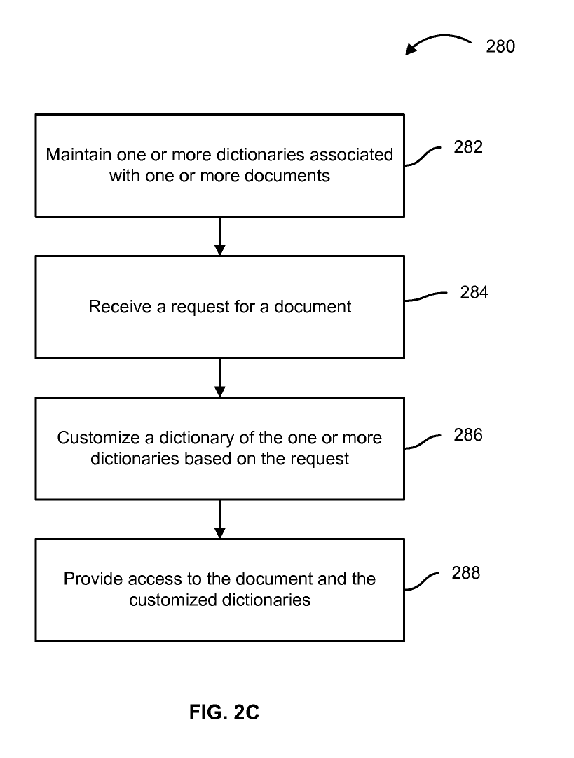

The processes and the dictionaries may be installed on computing device 100 at various times. For example, browser application 118 and device dictionary 116 may be pre-installed on the computing device. In comparison, when the user downloads, for example, reader application 110 from a computing resource of the service provider (e.g., a website or a data store), the application and application dictionary 114 may be installed on computing device 100 at that time. Likewise, when the user purchases document 104 from the service provider (e.g., when computing device 100 downloads the document from the data store), custom dictionary 112 may also be downloaded and stored on the computing device along with the document. Example flows for obtaining custom dictionary 112 are illustrated in FIGS. 2B and 2C.

The formats of document 104 and dictionaries 112, 114, and 116 may be common or may be different. For example, computing device 100 may store the document and dictionaries as files with different extensions. In yet another example, computing device 100 may merge one or more of these files in a single file. The existence of a plurality of dictionaries (e.g., dictionaries 112, 114, and 116) may be known or unknown to the user. For example, merging the dictionaries may be a process that may execute in the background of computing device 100 such that the user may be unaware of the different dictionaries and/or of the merging of some or all of the dictionaries.

As further shown in FIG. 1, each of the dictionaries can be presented in a separate window. However, embodiments herein are not limited to this configuration. For example, the service provider may set-up rules for displaying the windows. To illustrate, the service provider may require application dictionary 114 and device dictionary 116 to be merged and may allow the display of only two windows. This may result in computing device 100 displaying, for example, the window of custom dictionary 112 and a window for the two merged dictionaries. Likewise, the user may also have the option to configure user interface 102. For example, when the user purchases document 104, computing device 100 may present a window asking whether custom dictionary 112 and application dictionary 114 should be merged. If the user selects that option, computing device 100 may merge and store the two dictionaries in a single file and may display the merged dictionaries in a single window.

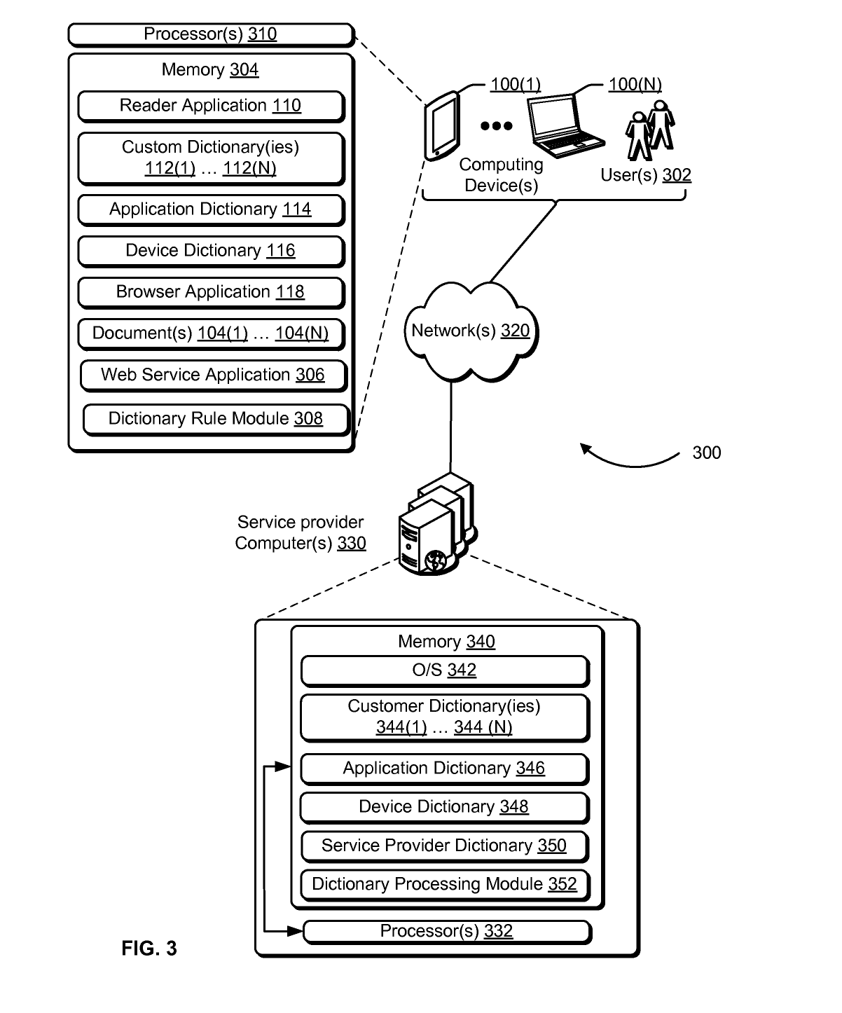

Although computing device 100 is described as storing document 104 and dictionaries 112, 14, and 116, embodiments herein are not limited to this configuration. As is further described in FIG. 3, a computing resource of the service provider can host document 104 and dictionaries 112, 14, and 116, whereas the one or more processes of computing device 100 may access the document and dictionaries over a network. For example, the computing resource may provide network-based services to computing device 100 or may run one or more instances within one or more virtual machines that may host document 104 and dictionaries 112, 14, and 116. In comparison, the one or more processes may include network-based browsers, similar to browser application 118, and/or application program interfaces (APIs).

To get a definition of object 106, the user may first select the object and optionally its context, triggering computing device 100 to retrieve the definition as further described in FIG. 2A. Various selection techniques of the object may be available. For example, computing device 100 may allow the user to select object 106 by clicking, swiping, or performing a certain touch screen gesture in its vicinity. Additionally or alternatively, the user may provide a voice command that reader application 110 may translate into a selection of object 106. Similar techniques may also be available to select context 108. Additionally, computing device 100 may store, for example, a rule such that reader application 110 may automatically select context 108 when the user selects object 106.

Turning to FIG. 2A, that figure illustrates an example flow 200 for presenting definitions of a selected object to the user. In illustrative flow 200, each of the operations may be embodied in, and fully or partially automated by, code modules executed by one or more processors of computing device 100 of FIG. 1. The code modules may be stored on any type of non-transitory computer-readable medium or computer storage device of computing device 100, such as hard drives, solid state memory, optical disc and/or other non-transitory medium. The results of the operations may be stored, persistently or otherwise, in any type of non-transitory computer storage such as, e.g., volatile or non-volatile storage. Also, while flow 200 is illustrated in a particular order, it should be understood that no particular order is necessary and that one or more operations or parts of flow 200 may be omitted, skipped, and/or reordered.

As shown in FIG. 2A, flow 200 may start at operation 202, where computing device 100 may receive a request to define an object. For example, computing device 100 may translate a user's selection of the object, described herein above, as a request for its definition. In another example, when the selection is made, computing device 100 may present a window asking the user whether he or she desires the definition. Upon receiving a command from the user, computing device 100 may proceed accordingly.

At operation 204, computing device 100 may determine whether the object has a definition in a custom dictionary. This definition may be referred to herein as a “custom definition.” For example, application reader 110 may search custom dictionary 112 using the object to find the custom definition. Alternatively, application reader 110 may provide the object to a process associated with custom dictionary 112. In turn, the process may look up the custom definition. If one is found, operation 206 may be performed. Otherwise, operation 208 may follow operation 204. As noted, custom dictionary 112 may be specific to document 104 and may be rendered accessible to computing device 100 (e.g., downloaded to the computing device from a data store associated with the service provider) when document 104 is also accessible thereto (e.g., downloaded to the computing device from the data store). Example flows for rendering custom dictionary 112 accessible to computing device 100 are further described in FIGS. 2B and 2C.

At operation 206, computing device 100 may return the custom definition. For example, application reader 110 may cause a generation of a window that may present the custom definition to the user. In another example, the process associated with custom dictionary 112 may present the custom definition in a window.

At operation 208, computing device 100 may determine whether the object has a definition in an application dictionary. This definition may be referred to herein as an “application definition.” For example, application reader 110 may search application dictionary 114 using the object to find the application definition. Alternatively, application reader 110 may provide the object to a process associated with application dictionary 114. In turn, the process may look up the application definition. If one is found, operation 201 may be performed. Otherwise, operation 212 may follow operation 208. An example flow for rendering application dictionary 114 accessible to computing device 100 is further described in FIG. 2C

At operation 210, computing device 100 may return the application definition. For example, application reader 110 may cause a generation of a window that may present the application definition to the user. In another example, the process associated with application dictionary 114 may present the application definition in a window.

At operation 212, computing device 100 may determine whether the object has a definition in a device dictionary. This definition may be referred to herein as a “device definition.” For example, application reader 110 may search device dictionary 116 using the object to find the device definition. Alternatively, application reader 110 may provide the object to a process associated with device dictionary 116. In turn, the process may look up the device definition. If one is found, operation 214 may be performed. Otherwise, operation 216 may follow operation 208. An example flow for rendering device dictionary 116 accessible to computing device 100 is further described in FIG. 2C

At operation 214, computing device 100 may return the device definition. For example, application reader 110 may cause a generation of a window that may present the device definition to the user. In another example, the process associated with device dictionary 116 may present the device definition in a window.

At operation 216, computing device 100 may determine whether a definition of the object can be retrieved from a service provider dictionary. This definition may be referred to herein as a “service provider definition.” Various constraints may apply at this operation. For example, a network connection between computing device 100 and a computing resource hosting the service provider dictionary may not be available. In another example, even though the connection may be available, computing device 100 be roaming or may not have the credentials or authorization to retrieve the service provider definition. If the service provider definition can be retrieved, operation 218 may be performed. Otherwise, operation 220 may follow operation 216.

At operation 218, computing device 100 may establish a network connection with the computing resource hosting the service provider dictionary. This connection may include an exchange of information such that the service provider definition may be returned to computing device 100. For example, computing device 100 may transmit the object and, optionally, its context to the computing resource by way of browser application 118. The transmission may cause, in turn, the computing resource to look up and return the service provider definition using the object and, optionally, the context. Also, this transmission may cause the computing resource to return an example of use of the object and/or to store the context for additional processing as is further described herein below. When computing device 100 receives the service provider definition, the computing device may display the received definition in a window.

Additionally, at operation 218, computing device 100 may receive instructions from the computing resource to store the service provider definition and, optionally, the example of use in one or more of dictionaries 112, 114, and 116. In another example, the instructions may cause computing device 100 to present a window to the user asking him or her to select one or more of dictionaries 112, 114, and 116 for storing the definition and, optionally, the example of use. In these two examples, computing device 100 may also present the service provider definition to the user in a similar way as under operations 206, 210, and 214. Procedures performed by the computing resource under operation 218 are further described in the following figures.

At operation 220, computing device 100 may return an indication to the user that the object could not be defined. For example, computing device 100 may display a window at user interface 102 describing the reason(s) for not finding the definition.

As is explained herein above, operations 202-220 need not be performed in the order described above. Likewise, one or more steps of operations 202-220 may be omitted, skipped, and/or reordered. In particular, one or more rules may be defined to set-up precedence or a hierarchy between the dictionaries. For example, when computing device 100 downloads document 104, in addition to also downloading custom dictionary 112, the computing device may also download and store a rule that may authorize the computing device to only use either custom dictionary 112 or the service provider dictionary. In another example, computing device 100 may provide an interface to the user to define his or her preferred order for performing the operations. In yet another example, computing device 100 may store a service provider-generated rule that may requires, for instance, the device dictionary to be checked first.

Turning to FIG. 2B, that figures illustrates an example flow 250 for obtaining a custom dictionary associated specifically with a document. This flow may be implemented by a computing device to obtain the custom dictionary (e.g., custom dictionary 112) and the document (e.g., document 104). In the interest of clarity of explanation, computing device 100 is described as performing operations of flow 250 to retrieve information from a computing resource of a service provider. Nevertheless, one of ordinary skill in the art will appreciate that the computing resource may perform corresponding operations to provide the information to computing device 100. Similarly, other processes, systems, or combination thereof can be used and should be apparent to those skilled in the art. For example, the computing resource may implement similar operations such that the computing resource may host the custom dictionary and the document (e.g., as one or more instances on one or more virtual machines) and may provide computing device 100 with access thereto to over a network.

Flow 250 may start at operation 252, where computing device 100 may receive a request to obtain a document. For example, computing device 100 may display a list of documents that a user may select from (e.g., by way of graphical user interface 102 or another interface). This list may be received at computing device 100 from a computing resource of a service provider (e.g., a data store) and may include one or more documents (e.g., books, multimedia files, or other documents) that may be offered to the user (e.g., available for download at a certain cost or for free). Based on a selection associated with the user, computing device 100 may determine which document needs to be obtained from the computing resource.

At operation 254, computing device 100 may request the document from the computing resource. For example, computing device 100 may connect to the computing resource and exchange information that may identify the document and, optionally, the user. In turn, the computing resource may authenticate the user, determine whether he or she may be authorized to access the document, apply any billing, update an account of the user, and transmit a copy, a version, and/or portions of the document to computing device 100. This transmission may be based on the information about the user. For example, a copy transmitted to an expert reviewer may be different than a copy transmitted to a casual reader. Similarly, the copy transmitted to the casual reader may be similar to or different from a copy transmitted to another casual reader and the two copies may be associated with two different licenses based on accounts of the two readers.

Additionally, the computing resource may determine a custom dictionary that may be uniquely associated with the document. For example, the computing resource may have access to custom dictionaries and documents and may maintain associations between the custom dictionaries and the documents. Based on information about the document and, optionally, the user, the computing resource may determine a custom dictionary that is specific to the requested document and available to the user (e.g., a custom dictionary to be transmitted to an expert reviewer may be different than a custom dictionary sent to a casual reader). A copy, a version, and/or portions of this custom dictionary may be transmitted to computing device 100.

At operation 256, computing device 100 may obtain the document and the custom dictionary from the computing resource. For example, computing device 100 may receive and store the transmitted copies of the document and the custom dictionaries from the computing resource. The copies may be stored as different files, can have the same or different extensions, or can be merged in a single file. Such functionalities can be implemented based on rules as further described herein below.

It should also be apparent to one skilled in the art that other flows may also be implemented to obtain a custom dictionary. For example, flow 250 may be partially or fully automated. To illustrate, when the user selects the document for download, computing device 100 may perform operations 252-256 such that the document and the associated custom dictionaries are automatically downloaded and stored on the computing device based on various rules and transparently to the user. These rules may specify how the document and the custom dictionary can be stored, including whether file locations and whether the document and the custom dictionary can be merged. In another example, flow 250 may include on-demand operations that allow the user to perform certain selections. For example, computing device 100 may allow the user to not only select a document, but to also select an associated custom dictionary. To illustrate, computing device 100 may display information about available documents and information about one or more available custom dictionaries specific to each document to the user. This information may be based on user information exchanged between computing device 100 and the computing resource. In turn, when the user selects a document and an associated custom dictionary, computing device 100 may obtain copies, versions, and/or portions thereof from the computing resource.

Turning to FIG. 2C, that figures illustrates an example flow 280 for maintaining dictionaries. This flow may be implemented by the computing resource of the service provider to manage access of computing device 100 to one or more dictionaries. The one or more dictionaries may include any of custom dictionary 112, application dictionary 114, and device dictionary 116. In the interest of clarity of explanation, the computing resource is described as performing operations of flow 280. Nevertheless, one of ordinary skill in the art will appreciate that computing device 100 may perform corresponding operations to access the one or more dictionaries.

Flow 280 may start at operation 282, where the computing resource may maintain the one or more dictionaries. For example, the computing resource may generate and/or store custom dictionary 112, application dictionary 114, and/or device dictionary 116. Also, the computing resource may monitor objects of documents that may be associated with the one or more dictionaries and may determine when any of these objects is hot. In that case, the computing resource may obtain definitions of the hot objects and update the one or more dictionaries accordingly.

At operation 284, the computing resource may receive a request for a document. This operation may correspond to operation 254 of FIG. 2B. More particularly, at operation 284, the computing resource may connect to computing device 100 and exchange information that may identify the document and, optionally, the user. Based on this information, the computing resource may authenticate the user, determine whether he or she may be authorized to access the document, apply any billing, update the account of the user, and customize a copy, a version, and/or portions of the document and/or a dictionary as is described at operations 286 and 288.

At operation 286, the computing resource may customize a dictionary of the one or more dictionaries based on the request. This operation may include the computing resource determining a type (e.g., whether the dictionary should be a custom dictionary, an application dictionary, or a device dictionary) and content (e.g., what definitions should be included) of the dictionary. For example, the computing resource may determine the type based on the information about the document and/or the user. To illustrate, if the document identified in the request includes objects that are not popularly used across multiple documents, the computing resource may set the type to a custom dictionary. If the account of the user indicates that the user should have access to a device dictionary, the computing resource may set the type to a device dictionary. Further, the computing resource may populate the content of the dictionary not only with definitions of the most commonly used objects (which can be specifically associated with the document or can be more generally used across multiple documents), but may also include, for example, definitions of hot objects as further described in the next figures. At this operation, the computing resource may also customize the document based on the request. For example, based on the account of the user, the computing resource may select a certain version of the document.

At operation 288, the computing resource may provide computing device 100 access to the document and to the customized dictionary. As is described herein, providing access may include transmitting the document and the customized dictionary to computing device 100. Additionally or alternatively, providing access may include hosting the document and the customized dictionary on a resource accessible to computing device 100 over a network.

Turning to FIG. 3, that figure illustrates an example architecture 300 for requesting definitions from one or more computing resources of a service provider and returning the definitions to one or more computing devices of one or more users. In architecture 300, the one or more computing devices may be in communication with the one or more computing resources to implement a collaborative computing environment in which definitions, contexts, and comments about objects may be shared (or said differently, this information may be shared among the users themselves and between the users and the service provider). This environment may allow the service provider to track the documents, dictionaries, and versions thereof, stored at or available to each computing device, to track hot objects, and to update the various dictionaries accordingly.

In a basic configuration, one or more users 302 (e.g., device owners, readers, writers, reviewers, authors, etc., which may be referred to herein in the singular as “user 302” or in the plural as “users 302”) may utilize one or more computing devices 100(1)-100(N) (which may be referred to herein in the singular as “computing device 100” or in the plural as “computing devices 100) to access local applications (e.g., stored and/or executable by computing device 100, such as application reader 110 and processes to present definitions from dictionaries 112, 114, and 116), a web service application 306, a user account accessible through the web service application, or a web site or other network resource via one or more networks 320 (which may be referred to herein in the singular “network 320” or in the plural “networks 320”). In some aspects, web service application 306, web site, and/or user account may be hosted, managed, and/or otherwise provided by one or more computing resources of the service provider, such as by utilizing one or more service provider computers 330 (which may be referred to herein in the singular as “service provider computer 330” or in the plural as “service provider computers 330”).

In some examples, computing devices 100 may also be any type of computing devices such as, but not limited to, an e-book reader, a mobile phone, a smart phone, a personal digital assistant (PDA), a laptop computer, a thin-client device, a tablet PC, etc. In one illustrative configuration, computing devices 100 may contain communications connection(s) that allow computing devices 100 to communicate with a stored database, another computing device or server, user terminals, and/or other devices on networks 320. Computing devices 100 may also include input/output (I/O) device(s) and/or ports, such as for enabling connection with a keyboard, a mouse, a pen, a voice input device, a touch input device, a display, speakers, a printer, etc.

Computing devices 100 may also include at least one or more processing units (or processor(s)) 310 and one memory 304 and. Processor(s) 310 may be implemented as appropriate in hardware, computer-executable instructions, firmware, or combinations thereof. Computer-executable instruction or firmware implementations of processor(s) 310 may include computer-executable or machine-executable instructions written in any suitable programming language to perform the various functions described.

Memory 304 may store program instructions that are loadable and executable on processor(s) 310, as well as data generated during the execution of these programs. Depending on the configuration and type of computing devices 100, memory 304 may be volatile (such as random access memory (RAM)) and/or non-volatile (such as read-only memory (ROM), flash memory, etc.). Computing devices 100 may also include additional storage, which may include removable storage and/or non-removable storage. The additional storage may include, but is not limited to, magnetic storage, optical disks, and/or tape storage. The disk drives and their associated computer-readable media may provide non-volatile storage of computer-readable instructions, data structures, program modules, and other data for the computing devices. In some implementations, memory 304 may include multiple different types of memory, such as static random access memory (SRAM), dynamic random access memory (DRAM), or ROM.

Turning to the contents of memory 304 in more detail, the memory may include an operating system and the one or more application programs or services for implementing the features disclosed herein including web service application 306, application reader 110, custom dictionaries 112(1)-112(N) (which may be referred to herein in the singular as “custom dictionary 112” or in the plural as “custom dictionaries 112”), application dictionary 114, device dictionary 116, browser application 118, documents 104(1)-104(N) (which may be referred to herein in the singular as “document 104” or in the plural as “documents 114;” each of documents 104 may be associated with one or more of custom dictionaries 112), and a dictionary rule module 308. Dictionary rule module 308 may be configured to store one or more rules regarding how definitions may be presented to users 302 and what definitions may be stored in the dictionaries 114, 116, and 118. For example, dictionary rule module 308 may store the hierarchy rules described herein above, rules for deciding which of the dictionaries 114, 116, and 118 may store a received service provider definition, and rules for merging the dictionaries 114, 116, and/or 118.

In some examples, computing devices 100 may be in communication with service provider computers 330 via networks 320, or via other network connections. Networks 320 may include any one or a combination of many different types of networks, such as cable networks, the Internet, wireless networks, cellular networks, and other private and/or public networks. While the illustrated example represents users 302 accessing web service application 306 over networks 320, the described techniques may equally apply in instances where the users interact with service provider computers 330 via computing devices 100 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer systems, etc.).

As described briefly above, web service application 306 may allow users 302 to interact with service provider computers 330, such as to store, access, and/or manage data, develop and/or deploy computer applications, and/or host web content. Service provider computers 330, perhaps arranged in a cluster of servers or as a server farm, may host web service application 306. These servers may be configured to host a website (or combination of websites) viewable via computing devices 100 (e.g., browser application 118). Other server architectures may also be used to host web service application 306. Web service application 306 may be capable of handling requests from many users 302 and serving, in response, various user interfaces that can be rendered at computing devices 100 such as, but not limited to, a web site. Web service application 306 can interact with any type of web site that supports user interaction, including social networking sites, electronic retailers, informational sites, blog sites, search engine sites, news and entertainment sites, and so forth. As discussed above, the described techniques can similarly be implemented outside of web service application 306, such as with other applications running on computing devices 100.

Service provider computers 330 may, in some examples, provide computing resources such as, but not limited to, applications for purchase and/or download, web sites, web hosting, client entities, data storage, data access, management, virtualization, etc. Service provider computers 330 may also be operable to provide web hosting, computer application development, and/or implementation platforms, or combinations of the foregoing to users 302.

Service provider computers 330 may be any type of computing device such as, but not limited to, a mobile phone, a smart phone, a personal digital assistant (PDA), a laptop computer, a desktop computer, a server computer, a thin-client device, a tablet PC, etc. Service provider computers 330 may also contain communications connection(s) that allow service provider computers 330 to communicate with a stored database, other computing devices or server, user terminals, and/or other devices on network 320. Service provider computers 330 may also include input/output (I/O) device(s) and/or ports, such as for enabling connection with a keyboard, a mouse, a pen, a voice input device, a touch input device, a display, speakers, a printer, etc.

Additionally, in some embodiments, service provider computers 330 may be executed by one more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment. In some examples, service provider computers 330 may be in communication with computing devices 100 via networks 320, or via other network connections. Service provider computers 330 may include one or more servers, perhaps arranged in a cluster, or as individual servers not associated with one another.

In one illustrative configuration, service provider computers 330 may include at least one or more processing units (or processor(s)) 332 and one memory 340. Processor(s) 332 may be implemented as appropriate in hardware, computer-executable instructions, firmware, or combinations thereof. Computer-executable instruction or firmware implementations of processor(s) 332 may include computer-executable or machine-executable instructions written in any suitable programming language to perform the various functions described.

Memory 340 may store program instructions that are loadable and executable on processor(s) 332, as well as data generated during the execution of these programs. Depending on the configuration and type of service provider computers 330, memory 340 may be volatile (such as random access memory (RAM)) and/or non-volatile (such as read-only memory (ROM), flash memory, etc.). Service provider computers 330 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, memory 340 may include multiple different types of memory, such as static random access memory (SRAM), dynamic random access memory (DRAM), or ROM.

Additionally, the computer storage media described herein may include computer-readable communication media such as computer-readable instructions, program modules, or other data transmitted within a data signal, such as a carrier wave, or other transmission. Such a transmitted signal may take any of a variety of forms including, but not limited to, electromagnetic, optical, or any combination thereof. However, as used herein, computer-readable media does not include computer-readable communication media.

Turning to the contents of memory 340 in more detail, the memory may include an operating system (O/S 342), custom dictionaries 344(1)-344(N) (which may be referred to herein in the singular as “custom dictionary 344” or in the plural as “custom dictionaries 344”), an application dictionary 346, a device dictionary 348, a service provider dictionary 350, and one or more application programs or services for implementing the features disclosed herein including at least a dictionary processing module 352. Dictionaries 344, 346, and 348 of service provider computers 330 may be versions of dictionaries from which dictionaries 114, 116, and 118 of computing devices 100 may have been downloaded. Alternatively, dictionaries 344, 346, and 348 may be instances of dictionaries to which computing device 100 may have access to. In yet another example, dictionaries 344, 346, and 348 may be files, such as tables, that track the versions and the content of dictionaries 114, 116, and 118. In comparison, service provider dictionary 350 may be an extensive dictionary and may contain definitions of objects listed in dictionaries 114, 116, and 118 and of objects unlisted in these dictionaries but used in documents 104.

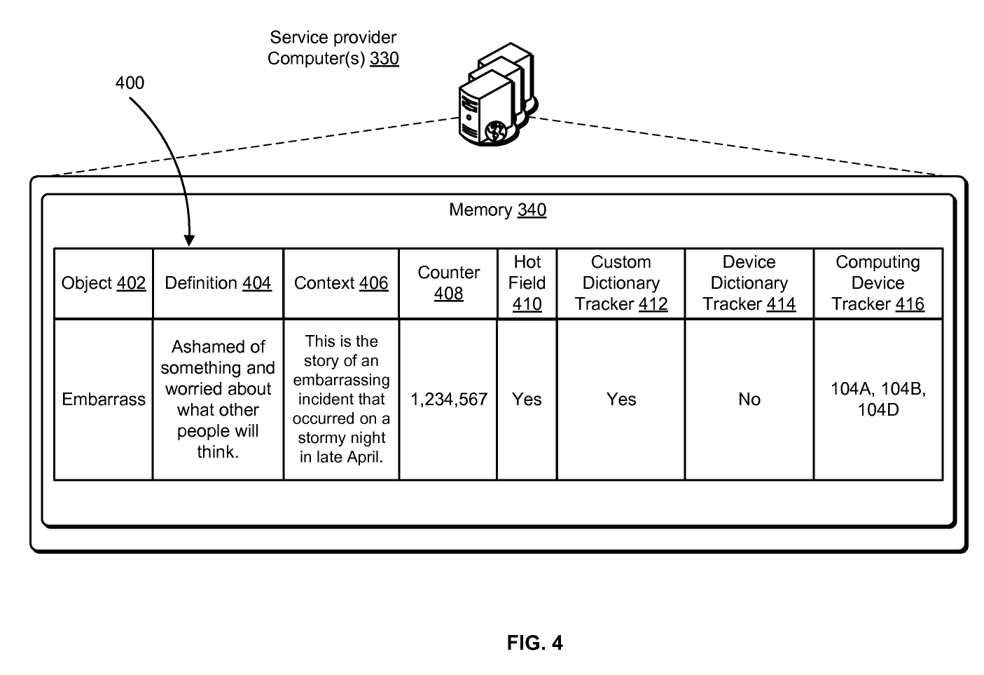

Dictionary processing module 352 may include processes for defining objects in dictionaries 114, 116, 118, 344, 346, 348 and 350. For example, dictionary processing module 352 may be configured to obtain definitions, contexts, and comments. To illustrate, this module may provide an interface to users 302 (including readers, writers, editors, authors, developers, etc.) by way of web service application 306 such that they can provide their definitions, contexts, and comments. Further, dictionary processing module 352 may maintain accounts associated with users 302 including profiles. As a user 302 collaborates in defining objects, dictionary processing module 352 may elevate his or her profile (e.g., from a casual reader to an expert editor). Based on the profile, dictionary processing module 352 may determine whether the user-provided definitions, along with the contexts and comments, can or cannot be added to service provider dictionary 350. Additional processes may be used, such as subjecting user-based definitions to a filtering algorithm that may rate the user-provided definitions, along with the contexts and comments for quality and relevance. In yet another example, dictionary processing module 352 may be configured to determine when an object becomes a hot object and which of the dictionaries 114, 116, 118, 344, 346, and 348 to store the definition in. This configuration is further described in greater detail below with reference to at least FIGS. 4-10.

Memory 340, memory 304, and the additional storage are examples of computer-readable storage media. For example, computer-readable storage media may include volatile or non-volatile, removable, or non-removable media implemented in any method or technology for storage of information such as computer-readable instructions, data structures, program modules, or other data. As used herein, modules may refer to programming modules executed by computing systems (e.g., processors) that are part of computing devices 100 or service provider computers 330.

Additional types of computer storage media that may be present in computing devices 100 or service provider computers 330 may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by computing devices 100 or service provider computers 330. Combinations of any of the above should also be included within the scope of computer-readable media.

Turning to FIG. 4, that figure illustrates an example structure 400 for tracking objects and their definitions and contexts. More particularly, the service provider may implement this structure to determine when an object becomes hot, the associated definition(s), context(s), comment(s), and example(s) of use, which dictionary(ies) the object needs to be defined in, and which computing device(s) requires an associated update.

Although FIG. 4 depicts structure 400 as a table with a plurality of entries, other data structures may be used, such as single and/or multi-dimensional arrays. Further, as shown in FIG. 4, structure 400 may be stored in memory 340 of service provider computer 330. In turn, service provider computer 330 may implement a process to update the plurality of entries of structure 400. However, other implementations may also be used. For example, structure 400 may be stored at a remote computing device that service provider computer 330 may have access to. Also, the service provider may use structure 400 to track objects across a plurality of documents and/or users. In another example, the service provider may use a single structure 400 per document and/or per user.

In the interest of clarity of explanation, structure 400 is illustrated as including entries for an object 402, a definition 404, a context 406, a counter 408, a hot field 410, a custom dictionary tracker 412, a device dictionary tracker 414, and a computing device tracker 416. Other entries may also be used, such as time stamps tracking when requests for definitions are received, comments, examples of uses, application dictionary trackers, document(s) that the objects are associated with, identifiers of users that have provided definitions, rules for storing the definitions in the dictionaries, etc.

Object 402 may list one or more objects that the service provider may be tracking. For example, when service provider computer 330 receives a request for a definition, the service provider computer may add the corresponding object to structure 400. In another example, the service provider may add all or a subset of objects contained in a document or in service provider dictionary 350 to structure 400. Likewise, definition 404 and context 406 may list one or more definitions and contexts, respectively, associated with the one or more objects. As explained herein above, these definitions and contexts may be obtained directly from users 302 or may be retrieved from service provider dictionary 350. In the latter case, definition 404 and context 406 may instead include pointers to service provider dictionary 350 and/or hashes of the one or more definitions and contexts.

Structure 400 may implement counter 408 to track objects. The service provider may use this counter to determine whether a tracked object may be hot based on a comparison of the counter with a threshold, as further described in the next figures. For each object, the counter may be initialized at a default value (e.g., “0”) and each time service provider computer 330 receives a request for its definition, the counter may be incremented. In an example, when the counter exceeds or approaches the threshold, the hot field 410 may be updated to reflect that the tracked object is hot indicating that the corresponding definition may need to be made available to computing devices 100. As illustrated in FIG. 4, the hot field 410 may be a binary field, where a “Yes” (or a “1”) may indicate that the object is hot and a “No” (or a “0”) may indicate otherwise and may be the default state. In another example, the service provider need not use counter 408 to determine whether a tracked object is hot. Instead, service provider computer 330 may update hot field 410 to “Yes” based on an event that may be independent of the counter. This event may be user-based and/or time-based. For example, when service provider computer 330 receives input associated with an author of a document that contains the object and when the input indicates that the object is hot (e.g., the input provides a definition and a request to add it to a dictionary), the service provider computer may toggle hot field 410 to “Yes.” Similarly, service provider computer 330 may initially set hot field 410 to “No,” may monitor the object over time and, based on a predefined timeframe, may toggle hot field to “Yes.”

Custom dictionary tracker 412 and device dictionary tracker 414 may be two entries that the service provider can use to track which dictionaries need to be updated with the definition. As illustrated in FIG. 4, these two entries may be binary fields with a “No” (or a “0”) as a default state indicating that the definition may not be added. On the other hand, structure 400 may toggle the state of one or both of these two entries to a “Yes” to indicate that the object may need to be added to the corresponding dictionary. For example, when the object becomes hot (e.g., the corresponding hot field 410 includes a “Yes”), the state of custom dictionary tracker 412 may become “Yes” indicating that custom dictionary 112 may need an update. As is further described in the next figures, the states of custom dictionary tracker 412 and device dictionary tracker 414 may be updated between “Yes” and “No” based on, for example, the requests for the definition, the object, the counter, and the threshold.

In another example, custom dictionary tracker 412 and device dictionary tracker 414 may be non-binary entries that may track additional information about the dictionaries. For instance, custom dictionary tracker 412 may identify some or all of the custom dictionaries that need to be updated. To illustrate, if two documents have two different custom dictionaries but contain a same hot object, custom dictionary tracker 412 may identify which of the two custom dictionaries may be updated. Similarly, device dictionary tracker 414 may identify which device dictionaries may be updated. For example, if two versions of a device dictionary exist and only one of the two versions needs to be updated, device dictionary tracker 414 may identify the corresponding version.

Structure 400 may also implement computing device tracker 416 to identify which computing devices may need to have their dictionaries updated with a definition of a hot object. For example, as service provider computer 330 receives requests from computing devices 100 for definitions of an object, and as service provider computer 330 accordingly updates counter 408, the service provider computer may also update computing device tracker 416 with identifiers of these devices. The identifiers may include, for example, network-based addresses of the computing devices and/or accounts of associated users 302. When the object becomes hot, service provider computer 330 may use the corresponding entries in computing device tracker 316 to determine the candidate computing devices that can receive the definition.

In another example, the service provider may use computing device tracker 416 to track associations between dictionaries and computing devices. For instance, when a computing device downloads a document and its custom dictionary, service provider computer 330 may update computing device tracker 416 accordingly. As such, when this custom dictionary may need to be updated with a definition of a hot object, service provider computer 330 may use the entry in computing device tracker 416 to determine that the computing device may need to receive the update.

In yet another example, the service provider may use computing device tracker 416 to customize the definition returned to users 302. For instance, service provider computer 330 may also track in this field information associated with users 302, such as information from their corresponding accounts. Based on this information, service provider computer 330 may return a definition that varies from one user to another. To illustrate, if a hot object is to be defined to two different users, one who may be a casual reader and the other an expert writer, service provider computer 330 may provide a basic definition with multiple examples of use to the computing device of the first user and a more elaborate definition with fewer examples of use to the computing device of the second user. Similarly, if the hot object is an equation from a math assignment and the first and second users are a student and a professor, respectively, the service provider may return a hint for solving the equation to the student and a detailed solution to the professor.

Further, FIG. 4 provides an example of an object (the word “embarrass”). However, structure 400 may not be limited to a single object as exemplified but may include some or all of the objects that the service provider may be tracking. As shown, “embarrass” can be defined as “ashamed of something and worried about what other people will think” and may have been used in the context of “this is the story of an embarrassing incident that occurred on a stormy night in late April.” The service provider may determine that the definition may have been requested 1,234,567 times and that this number of requests may exceed the threshold, rendering “embarrass” a hot object. Based on the requests and the counter, the service provider may determine that custom dictionary 112 may need to be updated with this definition and that computing devices 104A, 104B, and 104D may need to receive the update.

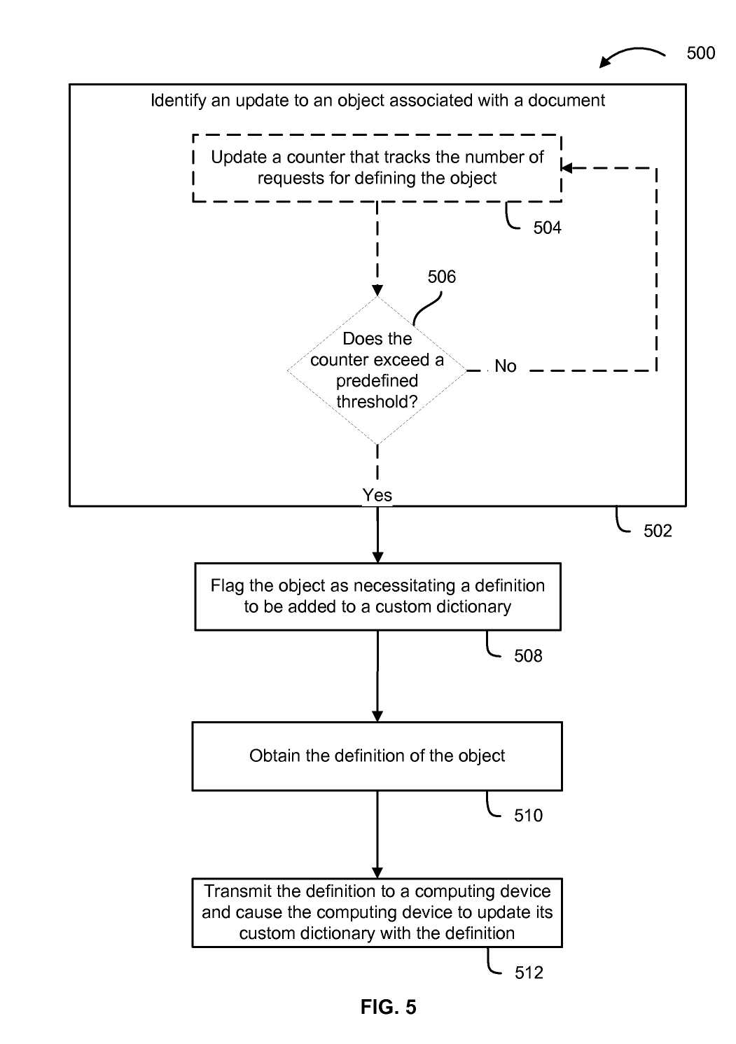

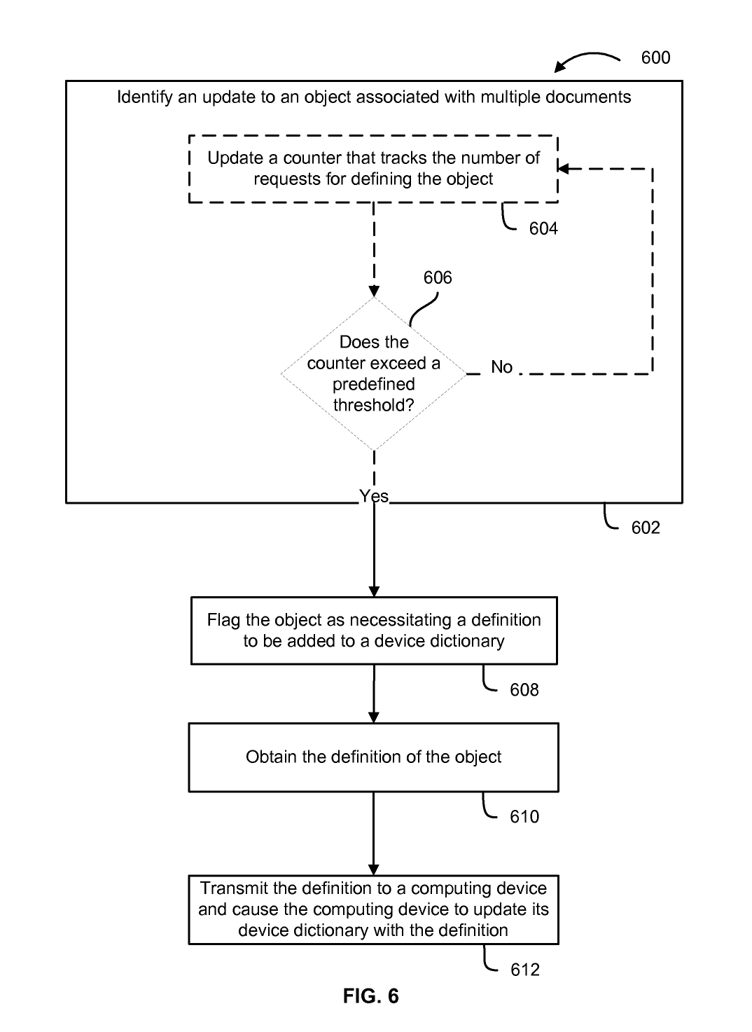

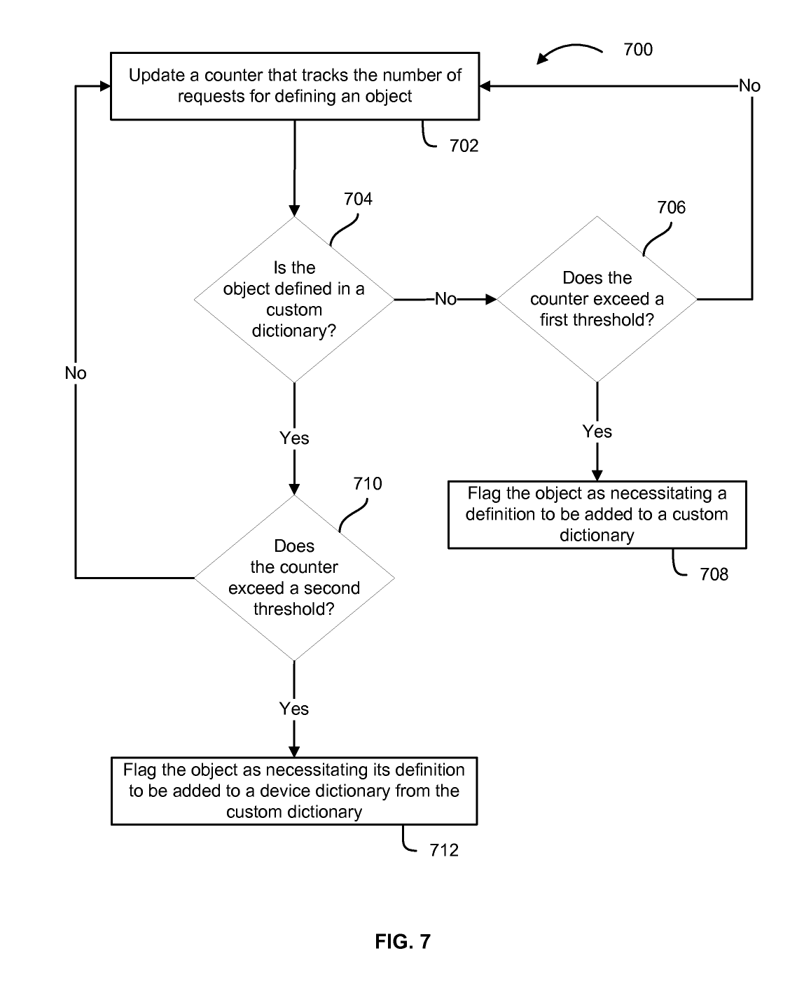

Turning to FIGS. 5 and 6, those figures illustrate example flows for adding a definition of an object to a local dictionary (e.g., custom dictionary 112) and global dictionary (e.g., device dictionary 116), respectively. The service provider may implement one of the two flows (or a combination thereof, as shown in FIG. 7) based on the requests for definitions. For example, if the requests are associated with a single document, service provider computers 330 may implement flow 500 of FIG. 5 to add the corresponding definition to a custom dictionary specific to that single document. On the other hand, if the requests are associated with multiple documents, service provider computers 330 may implement flow 600 to add the definition to a device dictionary. Furthermore, dictionary processing module 352, which is an example component of service provider computers 330, is described as performing the example flows. Nevertheless, other processes, systems, or combination thereof can be used and should be apparent to those skilled in the art.

As shown in FIG. 5, operation 502 may start flow 500, where service provider computer 330 may identify an update to an object associated with a document using various techniques. The update may relate to a definition of the object and may include, for example, an edit to an existing definition, an addition of a new definition, or a removal of an existing definition. One technique may implement operations 504 and 506 as described herein below. In another technique, service provider computer 330 may receive a request from, for example, an author of the document to update the definition. Based on this request, service provider computer may proceed to operation 508. In yet another technique, service provider computer 330 may identify the update based on a time interval. For example, the service provider may define a timeframe or a frequency at which updates to certain or all objects should occur. Accordingly, when the time interval elapses, service provider computer 330 may proceed to operation 508.

At operation 504, service provider computers 330 may update a counter that tracks the number of requests for defining the object. For example, service provider computers 330 may receive requests for defining the object from a plurality of computing devices 100, where the requests are associated with a same document that contain the object. In this example, dictionary processing module 352 may use an example of structure 400 that may be uniquely or specifically associated with the document and may increment the counter (e.g., counter 408) corresponding to the object based on the number of requests.

At operation 506, service provider computers 330 may compare the counter to a threshold to determine whether the threshold has been exceeded. The threshold may be predefined based on, for example, a number or a percentage associated with the document. For example, the threshold may be a preset percentage (e.g., 10%) of the number of times the document has been downloaded to computing devices 100 from service provider computers 330. If the counter has at least reached the threshold, dictionary processing module 352 may determine that the object is hot and may perform operation 508. Otherwise, dictionary processing module 352 may determine that the object is not hot. In this case, service dictionary processing module 352 may return the definition to computing device 100 and re-perform operation 504 when a subsequent request is received.

At operation 508, service provider computers 330 may flag the object as necessitating a definition to be added to the custom dictionary associated with the document. For example, dictionary processing module 352 may perform this operation by updating the hot field 410 to indicate that the object may be hot. Also, dictionary processing module 352 may update custom dictionary tracker 412 and computing device tracker 416 to identify the custom dictionary and the computing devices 100 that may need to receive the definition of the object.

At operation 510, service provider computers 330 may obtain the definition. For example, dictionary processing module 352 may use the corresponding definition available under definition 404. As explained herein above, this operation may involve retrieving the definition from service provider dictionary 350 or providing an interface to one or more users 302. Optionally, at this operation, dictionary processing module 352 may also retrieve other information associated with the definition, such as applicable contexts, examples of uses, and user-generated comments.

At operation 512, service provider computers 330 may transmit the definition and additional information to computing device 100 and may cause computing device 100 to accordingly update its custom dictionary associated with the document. The additional information may include the optional information determined at operation 510, an identifier of the custom dictionary, instructions to add the definition to the custom dictionary, and rules for merging definitions of the custom dictionary and the device dictionary. Further, in addition to updating the custom dictionary of computing device 100 that requested the definition, service provider computers 330 may cause other computing devices 100 identified at operation 508 to perform similar updates.

Turning to FIG. 6, flow 600 may start at operation 602, where service provider computer 330 may identify an update to an object associated with multiple documents using various techniques. The update may relate to a definition of the object and may include, for example, an edit to an existing definition, an addition of a new definition, or a removal of an existing definition. One technique may implement operations 604 and 606 as described herein below. In another technique, service provider computer 330 may receive requests from, for example, authors of the documents or other users to update the definition. The requests may identify the object and the documents. Based on the requests, service provider computer may proceed to operation 608. In yet another technique, service provider computer 330 may identify the update based on a time interval. For example, the service provider may define a timeframe or a frequency at which updates to certain or all objects should occur. Accordingly, when the time interval elapses, service provider computer 330 may proceed to operation 608.

At operation 604, service provider computers 330 may update a counter that tracks the number of requests for defining the object. For example, service provider computers 330 may receive requests for defining the object from a plurality of computing devices 100, where the requests are associated with multiple documents that contain the object. In this example, dictionary processing module 352 may retrieve an example of structure 400 that may be usable independently of the documents (e.g., not uniquely or specifically associated with a document) and may increment the counter (e.g., counter 408) corresponding to the object based on the number of requests.

At operation 606, service provider computers 330 may compare the counter to a threshold to determine whether the threshold has been exceeded. This threshold may but need not be the same threshold as the one under operation 506. At this operation, the threshold may be predefined based on, for example, a number or a percentage associated with users 302. For instance, the threshold may be a preset percentage (e.g., 2%) of the number of users 302, regardless of the number of actual users 302 who may have purchased the documents from the service provider. If the counter has at least reached the threshold, dictionary processing module 352 may determine that the object is hot and may perform operation 608. Otherwise, dictionary processing module 352 may determine that the object is not hot. In this case, service dictionary processing module 352 may return the definition to computing devices 100 and re-perform operation 604 when a subsequent request is received.

At operation 608, service provider computers 330 may flag the object as necessitating a definition to be added to the device dictionary associated with the document. For example, dictionary processing module 352 may perform this operation by updating the hot field 410 to indicate that the object may be hot. Also, dictionary processing module 352 may update device dictionary tracker 414 and computing device tracker 416 to identify the device dictionaries and computing devices 100 that may need to receive the definition of the object.

At operation 610, service provider computers 330 may obtain the definition of the object. For example, dictionary processing module 352 may use the corresponding definition available under definition 404 and, optionally, may also retrieve other information associated with the definition, such as applicable contexts, examples of uses, and user-generated comments.

At operation 612, service provider computers 330 may transmit the definition and additional information to computing devices 100 and may cause computing devices 100, as identified under operation 610, to accordingly update their device dictionaries. The additional information may include the optional information determined at operation 610 and, for each computing device 100, an identifier of the device dictionary, instructions to add the definition to the device dictionary, and rules for merging definitions between the various dictionaries.

Although flow 600 is described with regard to a device dictionary, service provider computers 330 may implement a similar flow to add a definition to an application dictionary or any other global dictionary. For example, when service provider computers 330 hosts a data store from which application reader 110 can be downloaded or when the service provider is an author of application reader 110, dictionary processing module 352 can perform operations 604-612 to determine when an object is hot, to obtain its definition, to determine the application dictionaries and computing devices 100 that should be updated, and to cause such an update.

Hybrid flows such as flows that combine operations from flows 500 and 600 may additionally be implemented. For example, the service provider can implement a flow that may first add a definition to a local dictionary and that may subsequently promote the definition to a global dictionary. FIG. 7 illustrates an example of such a flow as implemented by service provider computers 330. It should also be apparent to one skilled in the art that a similar flow may be performed by computing device 100.

As shown in FIG. 7, flow 700 may start at operation 702, where service provider computers 330 may update a counter that tracks the number of requests for defining an object. For example, each time a request associated with the object is received, dictionary processing module 352 may update the corresponding counter 408. At operation 704, service provider computers 330 may determine whether the object may already be defined in a custom dictionary. For example, dictionary processing module 352 may use custom dictionary tracker 414 to determine if and which custom dictionary the definition may already have been added to. If the object has not been defined in a custom dictionary, operation 706 may be performed; otherwise, operation 710 may be performed.

At operation 706, service provider computers 330 may determine whether the counter exceeds a first predefined threshold. For example, this operation can be similar to operation 506 of FIG. 5, where dictionary processing module 352 may determine whether the object may be hot. If so, operation 708 may be performed; otherwise, dictionary processing module 352 may return to operation 702. At operation 708, service provider computers 330 may flag the object as necessitating a custom dictionary in a similar way to operation 508 of FIG. 5

At operation 710, because the definition may have already been added to a custom dictionary, service provider computers 330 may determine whether the definition should be added to a device dictionary. To do so, dictionary processing module 352 may compare the counter to a second threshold, which may be a similar threshold as to the one used at operation 606 of FIG. 6. If the counter does not exceed the second threshold, dictionary processing module 352 may return to operation 702 because the object may not necessitate a device dictionary yet. Otherwise, operation 712 may be performed.

At operation 712, the object may already have a custom dictionary and may also need its definition to be made available to the device dictionary. This may be the case when, for example, an object was first used in a document and subsequently gained popularity and was used in other documents. To illustrate, in a series of novels, the object may be associated with a character of the series such as a hero or a villain. After the release of the first novel, the definition of the object (e.g., an image thereof) may be added to that novel's custom dictionary. With the release of the remaining novels in the series, the definition may be promoted from the custom dictionary to the device dictionary such that the definition becomes available to all of the novels in the series and to other documents (e.g., derivative works based on the series).

Returning to operation 712, at that operation, service provider computers 330 may flag the object as necessitating its definition to be added to a device dictionary from the custom dictionary. For example, dictionary processing module 352 may toggle the associated entry in device dictionary tracker 416 to “Yes” while also maintaining the associated entry in custom dictionary tracker in a “Yes” state. Having both states set to “Yes” may indicate that the definition need to be promoted to the device dictionary. This operation may also involve transmitting information to computing devices 100 to perform the promotion, such as instructions to add the definition to the device dictionary and, optionally, to remove the definition from the custom dictionary.

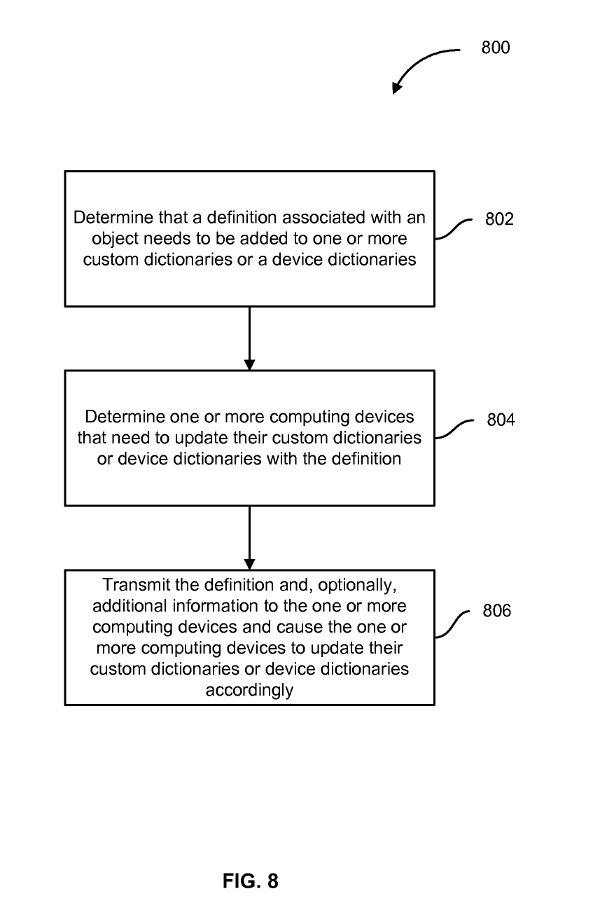

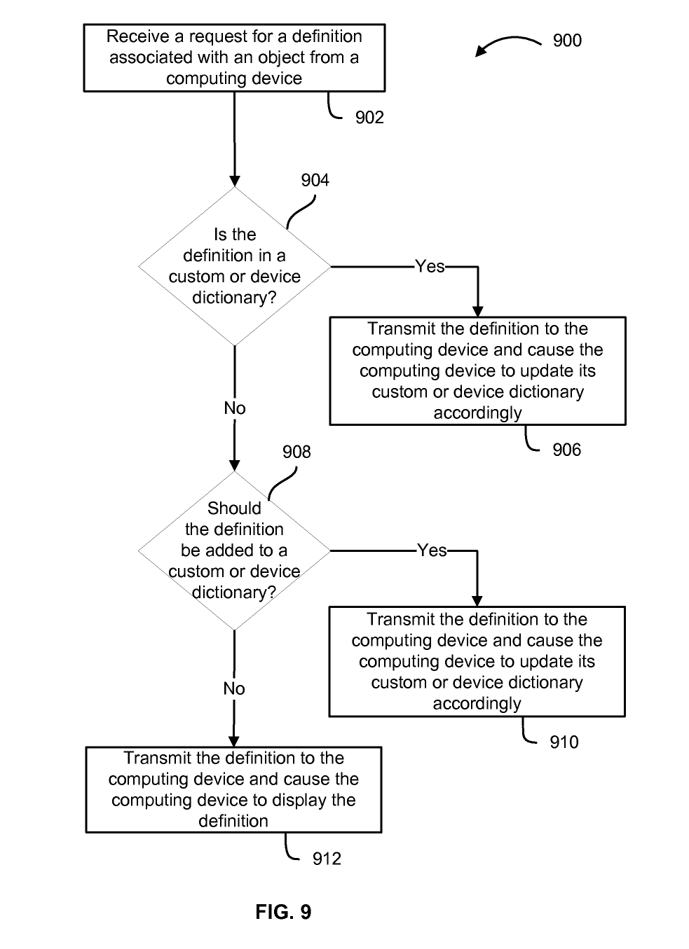

Once the service provider determines that an object is hot, the service provider can use various techniques to update the dictionaries of computing devices 100. The techniques include pushing the definition to the computing devices, as shown in FIG. 8. Additionally or alternatively, the techniques may allow computing devices 100 to pull the definition from service provider computers 330, as shown in FIG. 9

Turning to FIG. 8, an example flow 800 is illustrated for pushing definitions of hot objects from service provider computers 330 to computing devices 100. Flow 800 may start at operation 802, where service provider computers 330 may determine that a definition associated with an object may need to be added to one or more custom dictionaries or device dictionaries. For example, service provider computers 330 may implement any or a combination of operations from flows 500, 600, and 700 to perform this determination.

At operation 804, service provider computers 330 may determine one or more computing devices 100 that may need to the update to their custom or device dictionaries. Again, service provider computers 330 may, for example, implement any or a combination of operations from flows 500, 600, and 700 and may use computing device tracker 416 to make this determination.

At operation 806, service provider computers 330 may transmit the definition and, optionally, additional information to the one or more computing devices 100 and cause the one or more computing devices 100 to update their custom dictionaries or device dictionaries accordingly. At this operation, service provider computers 330 may broadcast the definition to the one or more computing devices 100 as soon as or shortly after determining that the object may be hot and obtains its definition. Alternatively, instead of pushing one definition at a time, service provider computers 330 may group a plurality of definitions for transmission based on various factors, such as time or connection-based factors. For example, service provider computers 330 may push the plurality of definitions at predefined time intervals, periodically, or following an event (e.g., a release of a new document). In another example, such definition push may occur when service provider computers 330 detect a certain type of available network connection (e.g., WiFi connections to computing devices 100).

In comparison, FIG. 9 illustrates an example flow 900 for pulling definitions of hot objects from service provider computers 330. As illustrated, flow 900 may include an on-demand flow, where computing devices 100 may request definitions of objects, and where service provider computers 330 may return the definitions with instructions to add the definitions to the local or global dictionaries (e.g. custom or device dictionaries, respectively) or to display the definitions in an application (e.g., browser application 118).

Flow 900 may start at operation 902, where service provider computers 330 may receive a request for a definition associated with an object from computing device 100. As explained herein above, the request may include identifiers of one or more of: the object, a document associated with the object, computing device 100, and corresponding user 302.

At operation 904, service provider computers 330 may determine whether the object may have already been flagged as hot and whether its definition may be added to a custom or device dictionary. For example, service provider computers 330 may use information from the request to search the various fields in an example structure 400 that tracks the object. If the object is already flagged as hot and its definition can be added to a custom or device dictionary, operation 906 may be performed, where service provider computers 330 may transmit the custom or device definition and, optionally, additional information to computing device 100 and may cause computing device 100 to update its custom or device dictionary accordingly. Otherwise, service provider computers 330 may perform operation 908.

At operation 908, if the object may not have already been flagged as hot, service provider computers 330 may determine whether the object should be flagged as so and add its definition to the custom or device dictionary associated with computing device 100. This determination may include any or a combination of operations from flows 500, 600, and 700. If the definition is to be added, service provider computers may 330 perform operation 910, where the service provider computers may transmit the definition and, optionally, additional information to computing device 100 and may cause computing device 100 to update its custom or device dictionary accordingly. Otherwise, service provider computers 330 may perform operation 912

At operation 912, service provider computers 330 may determine that the definition may not be added to the custom or device dictionary of computing device 100 (e.g., the object may not be hot or that computing device 100 may not be authorized to add the definition). In this case, service provider computers 330 may transmit the definition to computing device 100 and may cause computing device 100 to display the definition in a window independent of or separate from its custom or device dictionary, such as the window of browser application 118.

A definition of a hot object may, over time, become commonly known or understood. Such an object may be referred to herein as a “cold object.” For example, the words “Velcro” and “internet” may have been hot when they were first made available to the public but, since, they may have become cold objects and may not require their definitions to be in custom or device dictionaries. In another example, when the first novel in the Harry Potter series was released, the various characters may have been hot and may have necessitated custom definitions (e.g., images of the characters with descriptions of their roles). However, with releases of the remaining novels in the series, the characters may turn cold because they may have become familiar to the Harry Potter enthusiasts.

In certain situations, it may desirable to remove definitions of cold objects from local or global dictionaries of computing devices 100. This may, for example, free up memory space of computing devices 100 for other uses and may become prominent when such definitions are large in size (e.g., they are multimedia files) and/or a limited memory space is available at computing devices 100.

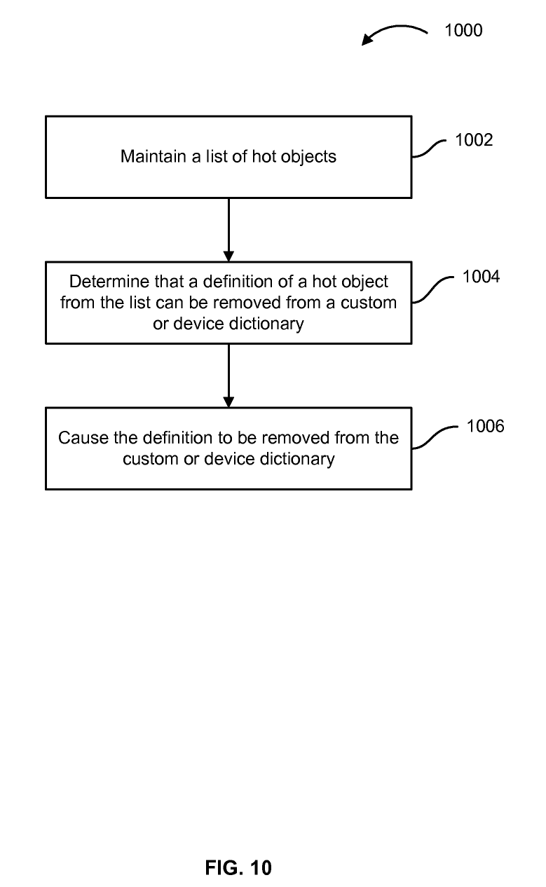

FIG. 10 illustrates an example flow 1000 for removing definitions of cold objects from local and/or global dictionaries. Service provider computers 330 may perform the operations of flow 1000 periodically, at intervals, or upon request from the service provider. Also, service provider computers 330 may perform the operations in response to a demand from computing devices 100. For example, when computing device 100 detects low memory space, the computing device may send a request to service provider computers 330 to identify the definitions that can be removed. In response, service provider computers may return a list of the cold objects.

Flow 1000 may start at operation 1002, where service provider computers 330 may maintain a list of hot objects. For example, the service provider can use structure 400 for this purpose and can run a process (e.g., dictionary processing module 352) to retrieve the list of hot objects along with identifiers of dictionaries that contain the corresponding definitions.

At operation 1004, service provider computers 330 may determine that a definition of a hot object from the list may be removed from a custom or device dictionary (e.g., the object may have turned from hot to cold). This operation may include a manual process, where service provider computers 330 may display the list to the service provider. In turn, the service provider may choose which hot objects from the list may be flagged as cold and, optionally, which dictionaries need to be updated. Additionally or alternatively, the process may be automated. For example, service provider computers 330 may track requests for a definition of a hot object over time and may determine that, at a certain point, the object may have become cold. To illustrate, dictionary processing module 352 may track increments to counter 408 of the corresponding object (or the number of requests for the definition) over time and may associate the increments with identifiers of the requesting computing devices. In this way, after defining the object in custom and/or device dictionaries, dictionary processing module 352 may determine the number of new requests (e.g., requests from computing devices that may not have yet received the definition) as a function of time. If at a certain point in time, dictionary processing module 352 determines that the number of new requests falls below a predefined threshold, the module may flag the hot object as cold and may determine which dictionaries need to be updated.

At operation 1006, service provider computers 330 may cause the definition of a cold object to be removed from the custom or device dictionary. For example, service provider computers 330 may transmit instructions to computing devices 100 identifying the cold object and requesting its definition to be removed from the corresponding custom and/or device dictionaries.

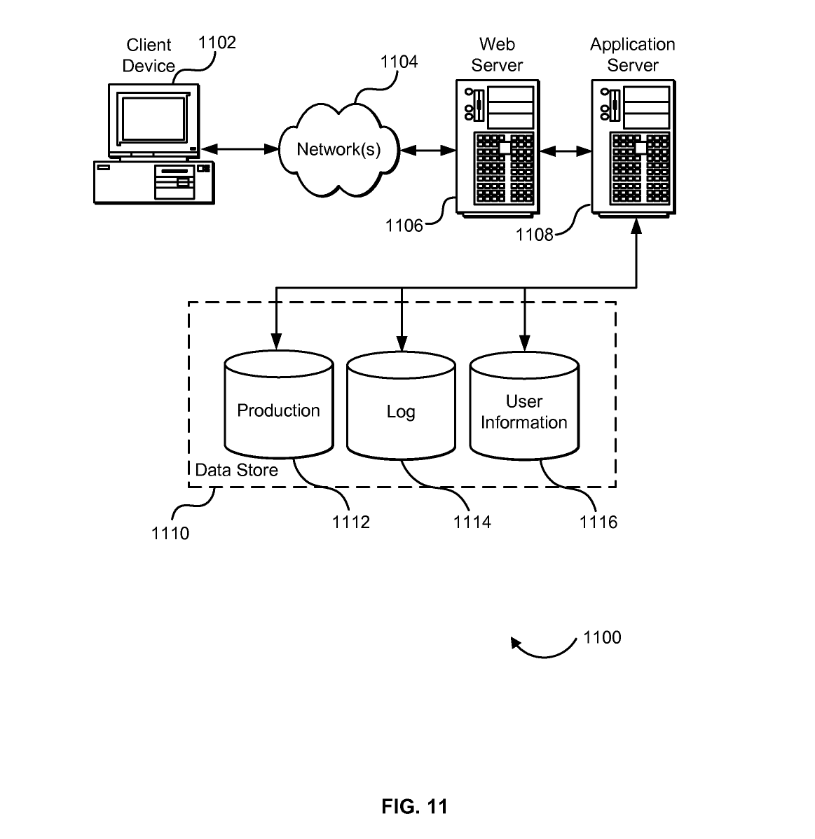

Turning to FIG. 11, that figure illustrates aspects of an example environment 1100 capable of implementing the above-described structures and functions. As will be appreciated, although a Web-based environment is used for purposes of explanation, different environments may be used, as appropriate, to implement various embodiments. The environment includes an electronic client device 1102, which can include any appropriate device operable to send and receive requests, messages, or information over an appropriate network(s) 1104 and convey information back to a user of the device. Examples of such client devices include personal computers, cell phones, handheld messaging devices, laptop computers, set-top boxes, personal data assistants, electronic book readers, or any other computing device. Network(s) 1104 can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1106 for receiving requests and serving content in response thereto, although for other networks an alternative device serving a similar purpose could be used as would be apparent to one of ordinary skill in the art.

The illustrative environment includes at least one application server 1108 and a data store 1110. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and/or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio and/or video to be transferred to the user, which may be served to the user by the Web server in the form of HTML, XML or another appropriate structured language in this example. The handling of all requests and responses, as well as the delivery of content between client device 1102 and application server 1108, can be handled by the Web server. It should be understood that the Web and application servers are not required and are merely example components, as structured code discussed herein can be executed on any appropriate device or host machine as discussed elsewhere herein.

Data store 1110 can include several separate data tables, databases or other data storage mechanisms and media for storing data relating to a particular aspect. For example, the data store illustrated includes mechanisms for storing production data 1112 and user information 1116, which can be used to serve content for the production side. The data store also is shown to include a mechanism for storing log data 1114, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in data store 1110. Data store 1110 is operable, through logic associated therewith, to receive instructions from application server 1108 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a web page that the user is able to view via a browser on client device 1102. Information for a particular item of interest can be viewed in a dedicated page or window of the browser.

Each server typically will include an operating system that provides executable program instructions for the general administration and operation of that server, and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 11. Thus, the depiction of environment 1100 in FIG. 11 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules or other data, including RAM, ROM, EEPROM, flash memory or other memory technology, CD-ROM, DVD, or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Disjunctive language such as that included in the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z in order for each to be present.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
in response to receiving a request from a computing device for a definition of a word:
incrementing, by a computer system configured with executable instructions, a counter associated with the word;
when the counter has at least reached a threshold, obtaining the definition from a source and determining a dictionary associated with the computing device for adding the definition; and
causing the dictionary to be updated with the definition.

2. The computer-implemented method of claim 1, wherein the dictionary is stored on the computing device, and wherein causing the dictionary to be updated with the definition comprises transmitting the definition to the computing device and instructing the computing device to update the dictionary with the definition.

3. The computer-implemented method of claim 1, wherein the word is associated with a document stored on the computing device, wherein the dictionary is uniquely associated with the document, and wherein the counter is incremented when the request is associated with the document.

4. The computer-implemented method of claim 1, wherein the dictionary is available to a plurality of documents stored on the computing device, and wherein the counter is incremented based at least in part on the request.

5. A computer-implemented method, comprising:
determining, by a computer system configured with executable instructions, a number of requests received from a plurality of computing devices for a definition associated with an object displayable at the plurality of computing devices;
comparing the number of the requests to a threshold; and
determining, based at least in part on the comparison, that the definition is to be added to a dictionary available to at least one computing device of the plurality of computing devices.

6. The computer-implemented method of claim 5, wherein the object comprises one or more of: a word, a formula, an equation, a character, an image, or a video.

7. The computer-implemented method of claim 5, wherein the object is associated with a document stored on the plurality computing devices, and wherein the dictionary is specific to the document.

8. The computer-implemented method of claim 7, wherein the requests are associated with the document.

9. The computer-implemented method of claim 5, wherein the dictionary is associated with a plurality of documents stored on the one or more computing devices.

10. The computer-implemented method of claim 9, wherein the requests are associated with the plurality of documents.

11. The computer-implemented method of claim 5, wherein the dictionary is stored on the computing device, and further comprising:
transmitting the definition to the at least one computing device; and
instructing the computing device to update the dictionary.

12. A system for using a definition of an object, comprising:
at least one memory that stores computer-executable instructions; and
at least one processor configured to access the at least one memory, wherein the at least one processor is configured to execute the computer-executable instructions to collectively at least:
identify an update associated with a definition of an object displayable at a plurality of computing devices;
determine, based at least in part on the update, at least one computing device of the plurality of computing devices and a dictionary available to the at least one computing device; and
cause the dictionary to be updated with the definition.

13. The system of claim 12, wherein the computing device stores a copy of the dictionary, and wherein causing the dictionary to be updated with the definition comprises:
transmit the definition to the computing device, wherein the transmission is based at least in part on a determination that the copy of the dictionary lacks the definition; and
instruct the computing device to update the copy of the dictionary by adding the definition.

14. The system of claim 13, wherein identifying the update comprises determining a number of requests received from the plurality of computing devices for the definition of the object, and wherein, when the number of requests exceeds a threshold, determining to add the definition to the dictionary.

15. The system of claim 14, wherein the requests comprise contexts for using the object, and wherein the at least one processor is further configured to transmit at least one context of the contexts to the computing device and cause the computing device to update the copy of the dictionary with the at least one context.

16. The system of claim 12, wherein the at least one processor is further configured to provide an interface to a user of a computing device of the plurality of computing devices for inputting the definition and to store the inputted definition in the memory or in storage associated with the system.

17. The system of claim 12, wherein the at least one processor is further configured to:
determine that a computing device of the plurality of computing devices has updated a copy of the dictionary with the definition, wherein the copy is stored on the computing device;
determine that the definition is to be removed from the copy; and
cause the computing device to remove the definition from the copy.

18. One or more computer-readable media storing computer-executable instructions for using a dictionary that, when executed by one or more computer systems, configure the one or more computer systems to perform operations comprising:
maintain one or more dictionaries;
in response to receiving a request from a computing device for access to a first document, customize a first dictionary from the one or more dictionaries based at least in part on an update associated with an object of the first document; and
transmit information about the first document and the first dictionary to the computing device, the information comprising instructions for accessing the first document and the first dictionary.

19. The one or more computer-readable media of claim 18, wherein the instructions for accessing the first document and the first dictionary comprises instructions for storing the first document and the first dictionary on the computing device.

20. The one or more computer-readable media of claim 19, wherein the instructions for storing the first dictionary on the computing device comprises instructions for merging at least a portion of the first dictionary with a second dictionary stored on the computing device, wherein the second dictionary is associated with the first document and a second document.

21. The one or more computer-readable media of claim 18, wherein the information transmitted to the computing device comprises the first document and the first dictionary.

22. The one or more computer-readable media of claim 18, wherein the first document comprises a plurality of objects, wherein the first dictionary comprises one or more definitions of one or more objects of the plurality of objects, and wherein the one or more objects are undefined in a second dictionary accessible to the computing device.

23. The one or more computer-readable media of claim 22, further comprising instructions that, when executed by the one or more computer systems, configure the one or more computer systems to perform operations comprising:
determine that the computing device has requested a definition of an object of the plurality of objects, wherein the object is undefined in the first dictionary and the second dictionary; and
transmit information to the computing device based at least in part on an update associated with a definition of the object, wherein the information comprises the definition and instructions to add the definition to the first dictionary.

24. The one or more computer-readable media of claim 22, wherein the computer-executable instructions when executed by the one or more computer systems, further configure the one or more computer systems to perform operations comprising:
determine that the computing device has requested a definition of an object of the plurality of objects, wherein the object is defined in the first dictionary;
determine that the object is associated with a second document stored on the computing device; and
transmit information to the computing device, the information comprising instructions to add the definition to the second dictionary.

25. The one or more computer-readable media of claim 18, wherein customizing the first dictionary comprises:
rendering, based at least in part on the request, the first dictionary available to one or more documents displayable at the computing device, the one or more documents comprising the first document; and
updating the first dictionary with a definition of the object when the update indicates that the definition has been requested at a number of times that exceeds a threshold.

26. The one or more computer-readable media of claim 18, wherein customizing the first dictionary comprises:
allowing, based at least in part on the request, access to the first dictionary in association with obtaining one or more definitions of one or more objects used in the first document and in a second document, wherein the second document is accessible to the computing device; and
updating the first dictionary with a definition of the object based at least in part on the update.
